(19) United States
(12) Patent Application Publication
(10) Pub. No.: US 2025/0187114 A1
(43) Pub. Date: Jun. 12, 2025

(54) Multibeam Systems Configured For Providing Surface Cleaning And Absorption Modification Functionality

(71) Applicant: Product Innovation and Engineering, LLC, St. James, MO (US)

(72) Inventor: Todd E. SPARKS, Rolla, MO (US)

(21) Appl. No.: 18/948,894

(22) Filed: Nov. 15, 2024

Related U.S. Application Data
(60) Provisional application No. 63/608,624, filed on Dec. 11, 2023.

(51) Int. Cl. B23K 26/342; B08B 7/00; B23K 26/067; B33Y 40/10

(52) U.S. Cl. CPC B23K 26/342; B08B 7/0042; B23K 26/067; B33Y 40/10

(57) ABSTRACT

Exemplary embodiments are disclosed of multibeam systems configured for providing surface cleaning and absorption modification functionality, e.g., to directed energy deposition (DED) processing, additive manufacturing, laser welding, laser powder bed fusion (LPBF), etc.

### CROSS-REFERENCE TO RELATED APPLICATION

The present application claims priority to and the benefit of U.S. Provisional Patent Application No. 63/608,624 filed Dec. 11, 2023. The entire disclosure of the above provisional application is incorporated herein by reference.

### FIELD

The present disclosure relates generally to additive manufacturing and more specifically to multibeam systems configured for providing surface cleaning and absorption modification functionality, e.g., to directed energy deposition (DED) processing, additive manufacturing, laser welding, laser powder bed fusion (LPBF), etc.

### BACKGROUND

This section provides background information related to the present disclosure which is not necessarily prior art.

Directed energy deposition (DED) is an additive manufacturing process also known as 3D printing. In DED, focused thermal energy is used to melt and fuse material as it is deposited layer by layer, building up a three-dimensional object. Unlike traditional subtractive manufacturing processes in which material is removed to create a part, additive manufacturing processes like DED add material only where it is needed.

In DED, a laser, an electron beam, or other focused energy source is directed onto a substrate or previously deposited material. Meanwhile, a feedstock material (e.g., powder, wire, etc.) is fed into the melt pool created by the focused energy source. The material solidifies as it cools thus forming the desired shape.

### DRAWINGS

The drawings described herein are for illustrative purposes only of selected embodiments and not all possible implementations, and are not intended to limit the scope of the present disclosure.

FIGS. 1(a) and 1(b) illustrate how the functional intent for the utility/secondary beam usage determines the utility beam's positioning relative to the main/primary beam according to exemplary embodiments of the present disclosure. FIG. 1(a) illustrates the utility beam positioned to work outside the main beam such that the system is configured for a cleaning mode, FIG. 1(b) illustrates the utility beam positioned to work inside the main beam such that the system is configured for an absorption mode.

FIGS. 2(a), 2(b), 2(c), and 2(d) illustrate exemplary pulse laser configurations with respect to the rain CW (continuous or constant wave) laser. The main laser's movement direction is specified with the arrow. FIG. 2(a) illustrates an example orbital pulse laser configuration. FIG. 2(b) illustrates an example offset with interaction pulse laser configuration. FIG. 2(c) illustrates an example offset without interaction pulse laser configuration. FIG. 2(d) illustrates an example adaptive leading pulse laser configuration.

FIGS. 3(a) and 3(b) respectively illustrate coaxial and off-axis utility/secondary beam delivery methods according to exemplary embodiments of the present disclosure. FIG. 3(a) illustrates an exemplary coaxial embodiment that employs a beam combining option to deliver both the main/primary beam and the secondary/utility beam down the same nominal axis. FIG. 3(b) illustrates an exemplary off-axis embodiment in which the utility/secondary beam is delivered from a different location entirely than the location from which the main/primary beam is delivered.

FIGS. 4(a), 4(b), and 4(c) shows three different multibeam system configurations according to exemplary embodiments of the present disclosure. FIG. 4(a) illustrates a multibeam system configured with coaxial secondary beam delivery and off-axis powder delivery. FIG. 4(b) illustrates a multibeam system configured with coaxial secondary beam delivery and coaxial powder delivery. FIG. 4(c) illustrates a multibeam system configured with off-axis secondary beam delivery and off-axis powder delivery.

FIG. 5 illustrates how the cleaning effect of the multibeam's secondary laser(s) reduces the impact of an oxide layer on print quality.

FIGS. 6(a) and 6(b) show bead cross sections from a demonstration printed in 4330V steel. FIG. 6(a) shown the bead cross sections without the secondary beam active. FIG. 6(b) shows bead cross sections with the secondary beam active. A comparison of FIG. 6(a) with FIG. 6(b) shows the modified wetting angles when the secondary beam cleaning process was not used (FIG. 6(a)) versus when the secondary beam cleaning process was used (FIG. 6(b)).

FIG. 7 shows the results of a demonstration conducted with a 1064 nanometer (nm) 500 Watt CW Nd:YAG (neodymium-doped yttrium aluminum garnet) main beam and 532 nm green Q-switched secondary beam.

FIGS. 8(a) and 8(b) respectively show the effects when operating the CW primary laser and the secondary pulse laser in orbital mode during deposition (FIG. 8(a)) and when operating the CW primary laser alone (without the secondary pulse laser) during deposition (FIG. 8(b)).

FIG. 9 is a line graph of absorption coefficient (%) versus temperature in degrees Celsius (° C.) for aluminum alloys, which shows absorption rates are dependent on both temperature and phase.

FIG. 10(a) shows an experimental apparatus for absorption measurements that was constructed to merge beams from a 1064 nm CW Nd:YAG laser and a 532 nm Q-switched, frequency doubled Nd:YAG laser.

FIG. 10(b) illustrates the setup for the experimental apparatus shown in FIG. 10(a).

FIGS. 11(a) and 11(b) include absorption line graphs of power in Watts (W) versus time in seconds (S), where the laser absorption was measured on a 6061 aluminum test specimen using the apparatus shown in FIG. 10(a). FIG. 11(a) shows that the average absorption rate was 8.94% for the 1064 nm CW primary laser alone at 200 Watts. FIG. 11(b) shows that the average absorption rate was 20.66% for the 1064 nm CW primary laser at 175 Watts and the 532 nm secondary laser at 25 Watts.

### DETAILED DESCRIPTION

Example embodiments will now be described more fully with reference to the accompanying drawings.

Exemplary embodiments were developed and/or are disclosed herein of multibeam technology for additive manufacturing that provides additional functionality to directed energy deposition (DED) processing. Through the addition of one or more secondary energy sources, exemplary embodiments of the multibeam systems disclosed herein add two distinctly new capabilities—(1) surface cleaning and (2) absorption modification.

The surface cleaning includes just-in-time removal of debris and surface oxides that improves the purity of the printed material, reduces porosity, and improves wetting of the printed material.

Regarding the absorption modification, shorter wavelengths tend to absorb better than long wavelengths in metals. Unfortunately, shorter wavelength lasers tend to be less powerful and more expensive. As recognized herein, exemplary embodiments leverage the typical optical behavior of metals wherein the liquid material absorbs light at a higher rate than the solid material. By utilizing the relatively high pulse energy of a secondary laser (broadly, secondary energy source), exemplary embodiments of the multibeam system disclosed herein can leverage the short, intense pulses of the secondary energy source that melts a thin film of the workpiece surface Then, the molten material absorbs the incident main beam radiation at a higher rate.

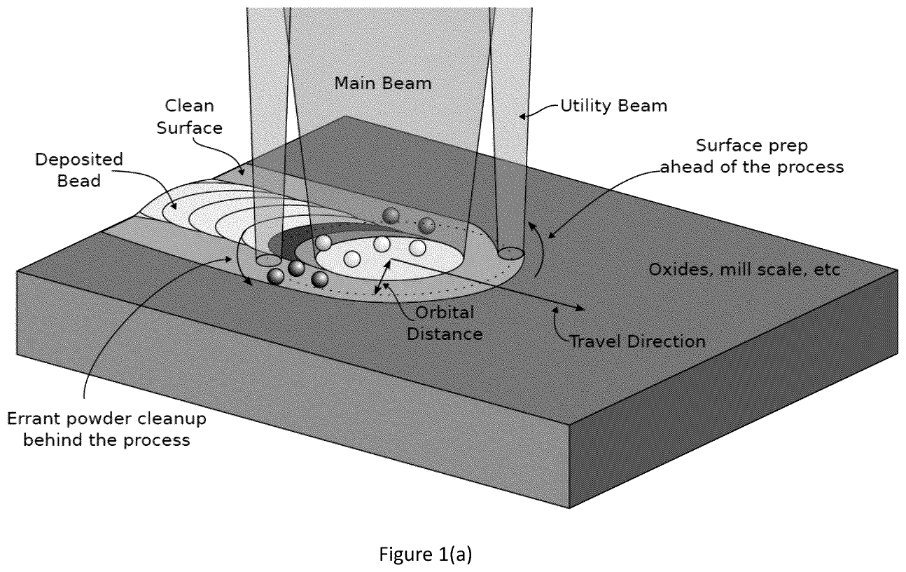

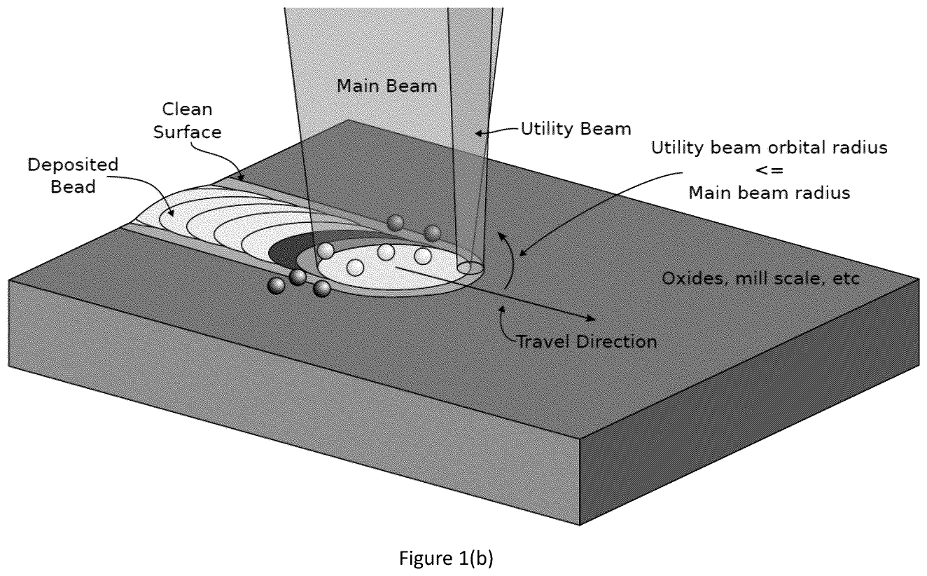

In exemplary embodiments, a multibeam DED system's beam delivery system comprises to classification, categories, types of energy sources, e.g., a primary/main energy source and one or more secondary/utility energy sources. FIG. 1 illustrates an exemplary embodiment of a multibeam DED system's beam delivery system including a main beam and a second beam.

The primary energy source (typically referred to as the “main beam”) provides the bulk of the energy to melt the base material. In a preferred embodiment, the main beam is a continuous or constant wave (CW) diode laser. But other laser types, arc welding sources, and primary energy sources are viable and may be used for the main beam in other exemplary embodiments.

The one or more secondary energy sources (typically referred to as “utility beam(s)”) perform one of several functions during the additive manufacturing (AM) process. In a preferred embodiment, the utility beam is a q-switched pulse laser capable of ablating the base material of interest. Another possible characteristic of the utility beam is being of a wavelength that will be preferentially absorbed by the material of interest. But other laser types and second energy sources are viable and may be used for the utility beam in other exemplary embodiments.

The beam steering implementation for the secondary laser could take many forms, such as an XY2-100 analog galvo laser scanner, a Risley prism scanner, a more complex structured light modulator, digital light processing (DLP) arrangement, etc. An important characteristic is for the steering solution to implement the desired pattern with respect to the main laser's position.

FIGS. 1(a) and 1(b) illustrate how the functional intent for the utility/secondary beam usage determines the utility beam's positioning relative to the main/primary beam according to exemplary embodiments of the present disclosure. When the utility beam works outside the main beam as shown in FIG. 1(a), the system is configured for cleaning mode. When the utility beam works inside the main beam as shown in FIG. 1(b), the system is configured for absorption mode.

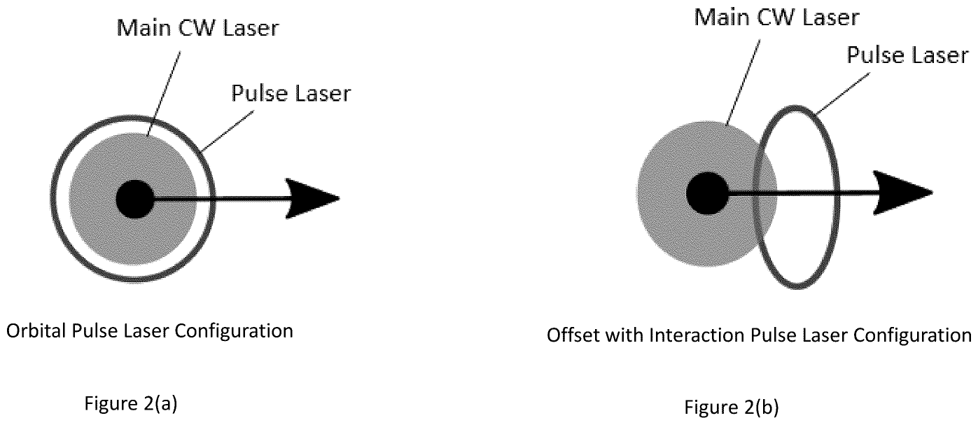

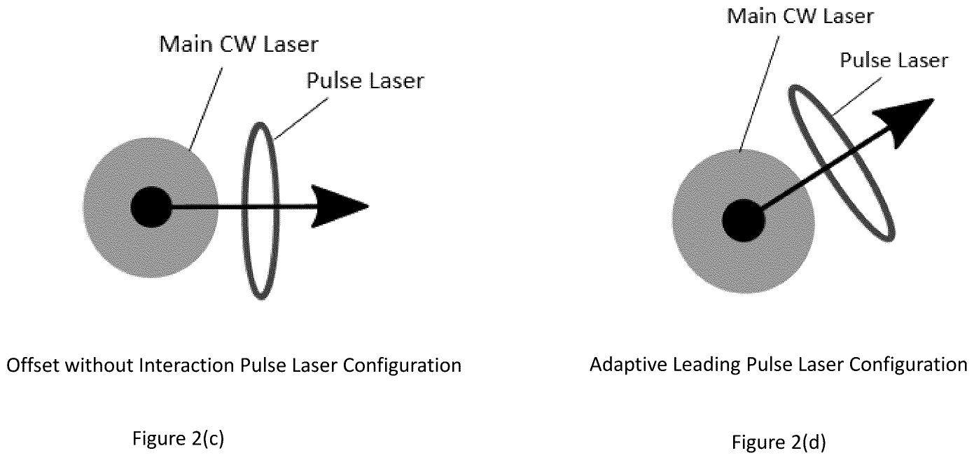

FIGS. 2(a), 2(b), 2(c), and 2(d) illustrate exemplary pulse laser configurations with respect to the main CW (continuous or constant wave) laser. The main laser's movement direction is specified with the arrow. More specifically, FIG. 2(a) illustrates an example orbital pulse laser configuration. FIG. 2(b) illustrates an example offset with interaction pulse laser configuration. FIG. 2(c) illustrates an example offset without interaction pulse laser configuration. FIG. 2(d) illustrates an example adaptive leading pulse laser configuration.

The orbital configuration shown in FIG. 2(a) was exclusively used during the demonstration efforts due to its simplicity to set up. An adaptive leading configuration shown in FIG. 2d with or without the option to interact with the melted material would be the preferred implementation. But the adaptive leading configuration shown in FIG. 2 would generally require tightly integrated controls with the motion system.

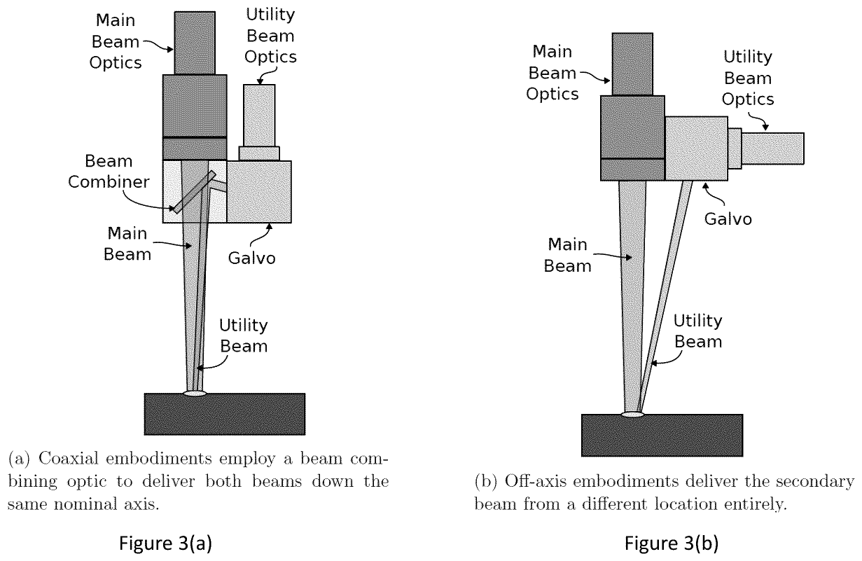

FIGS. 3(a) and 3(b) respectively illustrate coaxial and off-axis utility/secondary beam delivery methods according to exemplary embodiments of the present disclosure. As shown in FIG. 3(a), the coaxial embodiment employs a beam combining option to deliver both the main/primary beam and the secondary/utility beam down the same nominal axis. In the coaxial multibeam setup as shown in FIG. 3(a), a dichroic mirror or similar beam combining method is used to deliver both beams down the same optical axis. It is possible to steer the secondary beam to be co-linear with the main beam. This configuration provides the best possible access for the secondary beam to the material at and near the melt pool created by the main laser. A disadvantage of the coaxial configuration is the initial cost of the beam combining solution.

As shown in FIG. 3(b), the off-axis embodiment delivers the utility/secondary beam from a different location entirely than the location from which the main/primary beam is delivered. In the off-axis multibeam setup as shown in FIG. 3(b), the secondary beam is delivered from a position near the main beam delivery optics. This allows for the secondary beam to be co-incident but not co-linear with the main beam at a working plane. Additionally, the shadow of the printed material may result in uneven treatment of the material around the bead by the secondary laser. Although the coaxial secondary beam delivery shown in FIG. 3(a) is generally preferred, the off-axis secondary beam delivery shown in FIG. 3(b) may also be successfully implemented in multibeam systems as disclosed herein.

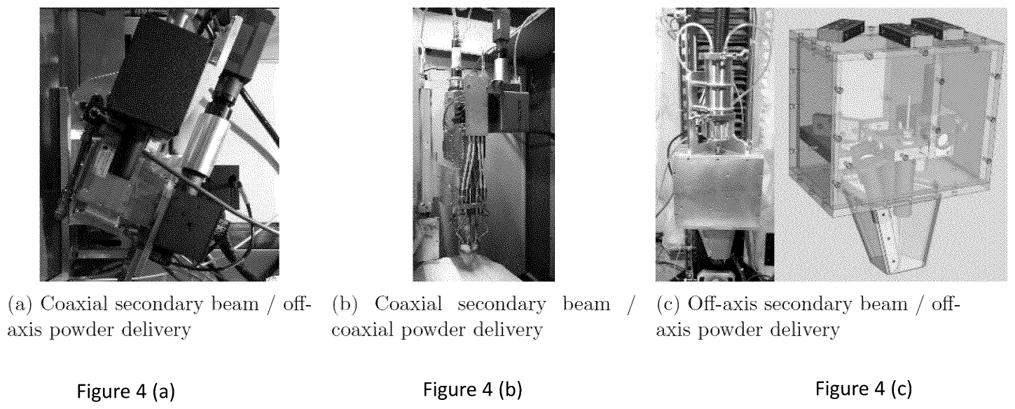

FIGS. 4(a), 4(b), and 4(c) shows three different multibeam system configurations according to exemplary embodiments of the present disclosure. FIG. 4(a) illustrates a multibeam system configured with coaxial secondary beam delivery and off-axis powder delivery. FIG. 4(b) illustrates a multibeam system configured with coaxial secondary beam delivery and coaxial powder delivery. FIG. 4(c) illustrates a multibeam system configured with off-axis secondary beam delivery and off-axis powder delivery. The coaxial secondary beam delivery (e.g., FIGS. 4(a) and 4(b), etc.) is generally preferred because the coaxial secondary beam delivery does not suffer from any shadowing effects (e.g., beam access issues caused by blocking geometry). The off-axis secondary beam delivery (e.g., FIG. 4(c), etc.) may also be successfully implemented in multibeam systems as disclosed herein.

### Demonstrated Effects—Cleaning

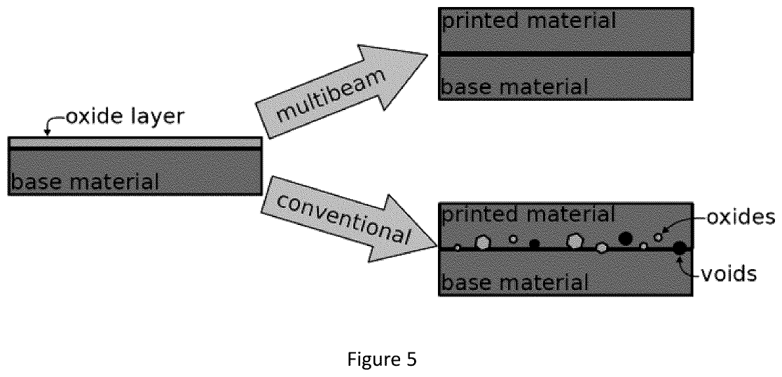

FIG. 5 illustrates how the cleaning effect of the multibeam's secondary laser(s) reduces the impact of an oxide layer on print quality. When the secondary beam(s) does not directly interact with the material melted by the main beam (e.g., FIG. 1(a), etc.), the primary effect of the secondary beam will be to ablate the base material's surface. The intent of this configuration is to remove oxides, oils, or other debris from the surface of the base material just before new material is added. As suggested in FIG. 5, failure to remove this oxide layer can result in some of the material being trapped within the newly solidified metal matrix. Additionally, breakdown products of debris can form gas porosity defects within the material.

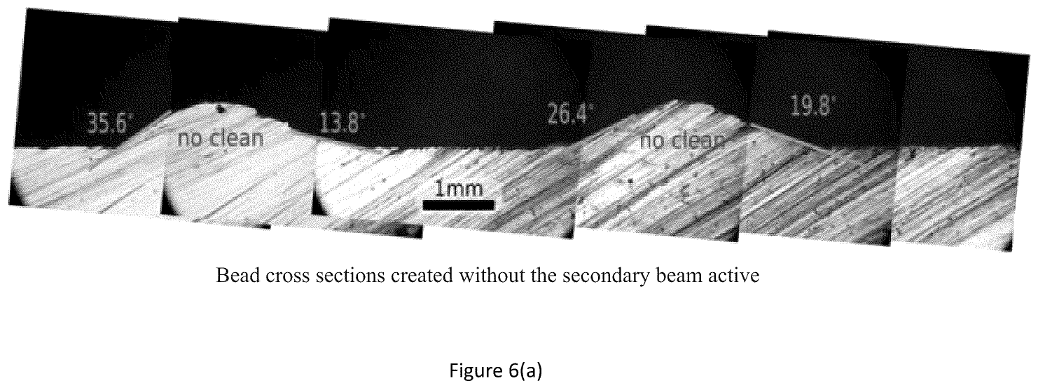

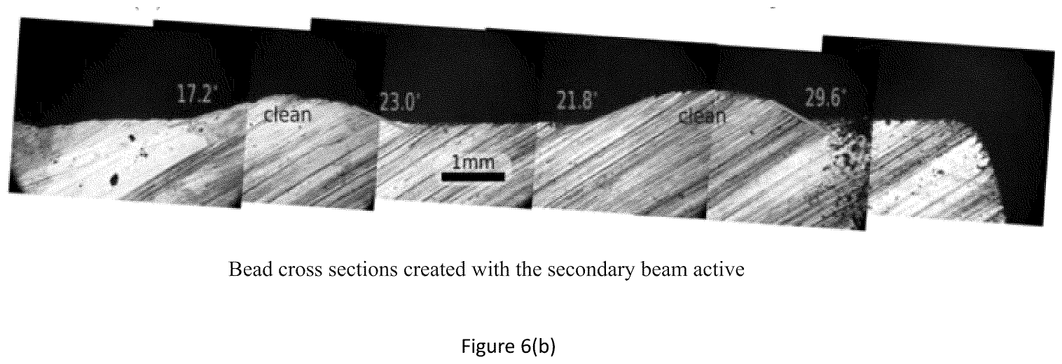

The removal of surface oxides modified the wetting angle of the liquid metal to the base material. To demonstrate this effect, a set of six beads were created, sectioned, and imaged. Examples of measured wetting angles can be observed in FIG. 6. More specifically, FIGS. 6(a) and 6(b) show bead cross sections from a demonstration printed in 4330V steel without the secondary beam active (FIG. 6(a)) and with the secondary beam active (FIG. 6(b)). A comparison of FIG. 6(a) with FIG. 6(b) shows the modified wetting angles when the secondary beam cleaning process was not used versus when the secondary beam cleaning process was used. Notably, the mean wetting angle for the beads with the cleaned base material was 21.4° versus 24.1° for the uncleaned material.

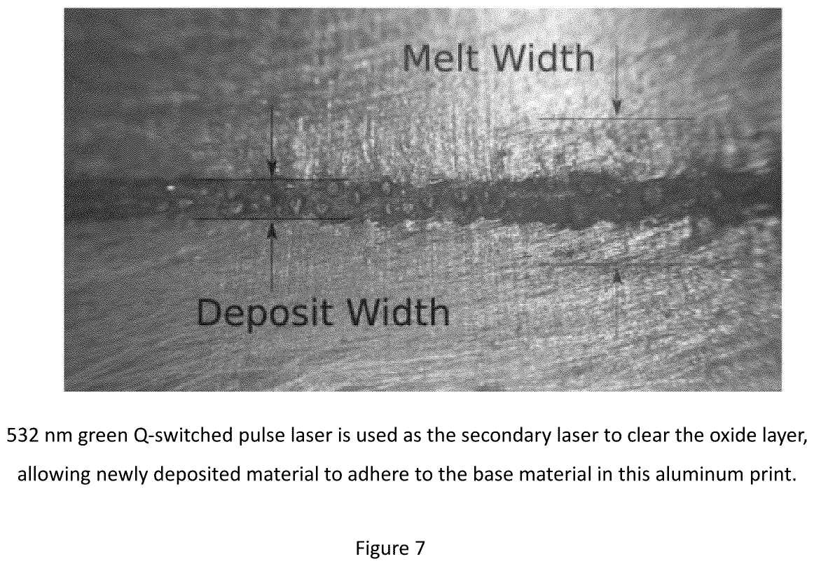

When working with aluminum alloys, a thick oxide layer can prevent adhesion of a bead entirely. FIG. 7 illustrates this effect via a demonstration conducted with a 1064 nanometer (nm) 500 Watt CW Nd:YAG (neodymium-doped yttrium aluminum garnet) main beam and 532 nm green Q-switched secondary beam. The actual melted width of the base material was significantly wider than the observed bead width. Only where the secondary laser removed the oxide was new material able to be deposited. This demonstration was conducted with a 1064 nm 500 W CW Nd:YAG main beam and 532 nm green q-switched secondary beam.

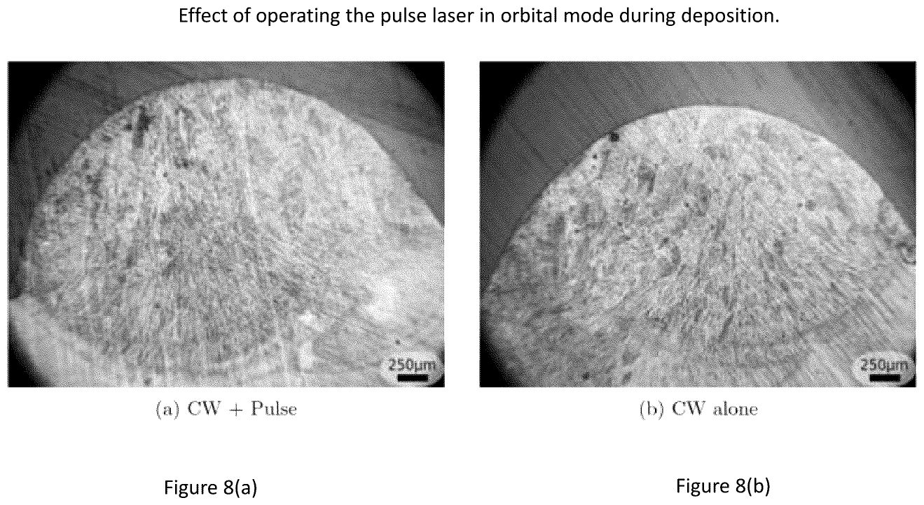

FIGS. 8(a) and 8(b) respectively show the effects when operating the CW primary laser and the secondary pulse laser in orbital mode during deposition (FIG. 8(a)) and when operating the CW primary laser alone (without the secondary pulse laser) during deposition (FIG. 8(b)). FIGS. 8(a) and 8(b) suggest that the usage of the secondary laser in an orbital mode during deposition may mitigate porosity formation.

### Demonstrated Effects—Absorption Modification

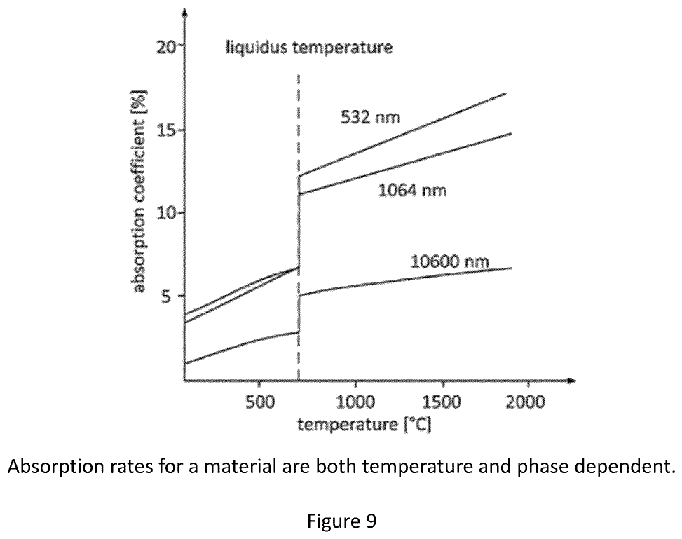

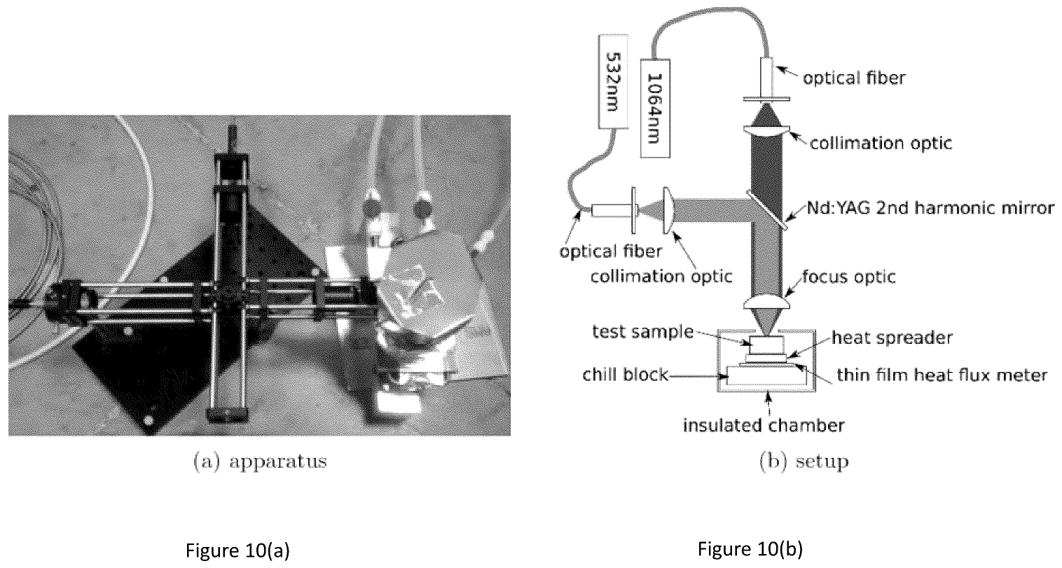

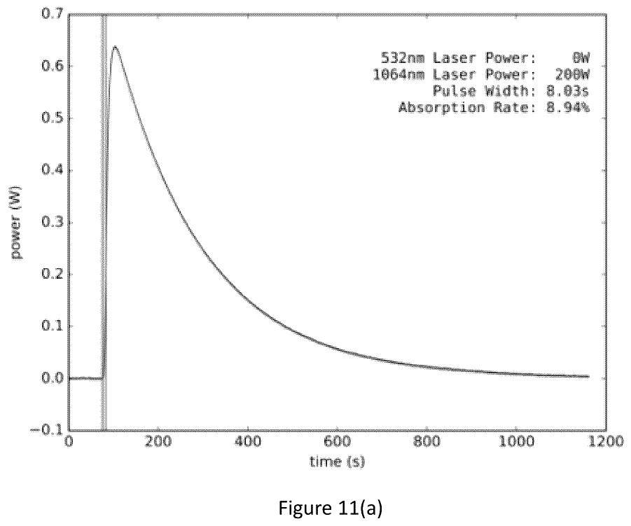

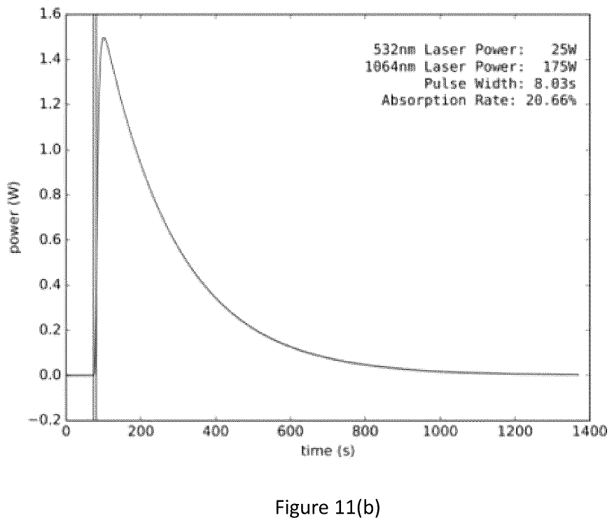

When the secondary beam(s) is positioned within the spot of the main beam (e.g., FIG. 1(b), etc.), the primary effect of the secondary beam will be to increase the effective absorption rate of the main beam. The mechanism by which this happens is that with each pulse from the secondary laser a small portion of the material within the main beam's temperature is increased, which increases rate at which the high CW power main beam is absorbed. The optical absorption for many materials increases with increasing temperature. Additionally, the liquid phase absorbs photons at a higher rate than the solid as well. This temperature and phase dependence is illustrated for aluminum alloys in FIG. 9. The agglomerate effect on effective laser absorption by the main and secondary beam interaction can be quite significant, as illustrated by the demonstration seen in FIGS. 10(a), 10(b), 11(a), and 11(b).

As shown in FIG. 10(A), an experimental apparatus was constructed to merge beams from a 1064 nm CW Nd:YAG laser and a 532 nm Q-switched, frequency doubled Nd:YAG laser. Laser absorption was measured on a 6061 aluminum test specimen. The 1064 nm CW laser was found to have an average absorption of 82% The combined 532 nm and 1064 nm beams averaged 15.4% absorption, an improvement of 87.7% over 1064 nm CW laser only.

FIGS. 11(a) and 11(b) include absorption line graphs of power in Watts (W) versus time in seconds (S), where the laser absorption was measured on a 6061 aluminum test specimen using the apparatus shown in FIG. 10. The average absorption rate was 8.94% for the 1064 nm CW primary laser alone at 200 Watts (FIG. 11(a)). The average absorption rate was 20.66% for the 1064 nm CW primary laser at 175 Watts and the 532 nm secondary laser at 25 Watts (FIG. 11(b)). These average absorption rates were generated by integrating the heat flux across an interface, which are on the conservative side.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multibeam system comprising:
a primary energy source operable for producing a main beam; and
one or more second energy sources operable for producing a utility beam(s);
wherein the multibeam system is configured to be operable for adjustably positioning the utility beam(s) relative to the main beam; and
wherein the utility beam(s) and main beam are configured differently such that the multibeam system is asymmetric; and/or
wherein the multibeam system is selectively configurable into:
a cleaning mode in which the utility beam(s) is positioned to work outside the main beam; and/or
an absorption modification mode in which the utility beam(s) is positioned to work inside the main beam.

2. The multibeam system of claim 1, wherein:
the multibeam system is configured for providing surface cleaning and absorption modification functionality; and
the multibeam system is configured to be operable for adjustably positioning the utility beam(s) relative to the main beam such that the multibeam system is selectively configurable into:
a cleaning mode in which the utility beam(s) is positioned to work outside the main beam; and
an absorption modification mode in which the utility beam(s) is positioned to work inside the main beam.

3. The multibeam system of claim 1, wherein:
the multibeam system is configured for providing surface cleaning or absorption modification functionality; and
the multibeam system is configured to be operable for adjustably positioning the utility beam(s) relative to the main beam such that the multibeam system is selectively configurable into:
a cleaning mode in which the utility beam(s) is positioned to work outside the main beam; or
an absorption modification mode in which the utility beam(s) is positioned to work inside the main beam.

4. The multibeam system of claim 1, wherein the utility beam(s) and main beam are configured differently such that the multibeam system is asymmetric.

5. The multibeam system of claim 1, wherein:
the multibeam system is configured to be operable for adjustably positioning the utility beam(s) relative to the main beam; and
the utility beam(s) and main beam are configured differently such that the multibeam system is asymmetric.

6. The multibeam system of claim 1, wherein:
the utility beam(s) and main beam are configured differently such that the multibeam system is asymmetric; and
the multibeam system is configured to be operable for adjustably positioning the utility beam(s) relative to the main beam such that the multibeam system is selectively configurable into:
a cleaning mode in which the utility beam(s) is positioned to work outside the main beam; and
an absorption modification mode in which the utility beam(s) is positioned to work inside the main beam.

7. The multibeam system of claim 1, wherein the multibeam system is configured such that the utility beam(s) is selectively positionable to work outside or inside the main beam.

8. The multibeam system of claim 1, wherein the multibeam system is configured such that the utility beam(s) is selectively positionable to work outside the main beam for cleaning and selectively positionable to work inside the main beam for absorption modification.

9. The multibeam system of claim 1, wherein:
the main beam comprises a continuous or constant wave laser; and
the utility beam(s) comprises a Q-switched pulse laser(s).

10. The multibeam system of claim 1, wherein the multibeam system comprises a beam steering mechanism for selectively adjusting the positioning of the utility beam(s) relative to the main beam.

11. The multibeam system of claim 1, wherein the main beam and the utility beam(s) are operable in a pulse laser configuration including one or more of an orbital pulse laser configuration, an offset with interaction pulse laser configuration, an offset without interaction pulse laser configuration, and an adaptive leading pulse laser configuration.

12. The multibeam system of claim 1, wherein the multibeam system is configured to have coaxial utility beam delivery in which the main beam and the utility beam(s) are delivered down and/or along a same optical axis.

13. The multibeam system of claim 1, wherein the multibeam system includes a dichroic mirror for delivering the main beam and the utility beam(s) down and/or along a same optical axis, whereby the utility beam(s) is steerable to be co-linear with the main beam.

14. The multibeam system of claim 1, wherein the multibeam system includes a beam combining mechanism for delivering the main beam and the utility beam(s) down and/or along a same optical axis, whereby the utility beam(s) is steerable to be co-linear with the main beam.

15. The multibeam system of claim 1, wherein the multibeam system is configured with coaxial utility beam delivery and off-axis powder delivery.

16. The multibeam system of claim 1, wherein the multibeam system is configured with coaxial utility beam delivery and coaxial powder delivery.

17. The multibeam system of claim 1, wherein the multibeam system is configured to have off-axis utility beam delivery in which the utility beam(s) is delivered from a location different than and spaced apart from a location from which the main beam is delivered.

18. The multibeam system of claim 1, wherein the multibeam system is configured to deliver the utility beam(s) from a position near main beam delivery optics, which thereby allows for the utility beam(s) to be co-incident but not co-linear with the main beam at a working plane.

19. The multibeam system claim 1, wherein the multibeam system is configured with off-axis utility beam delivery and coaxial powder delivery.

20. The multibeam system of claim 1, wherein the multibeam system is configured with off-axis utility beam delivery and off-axis powder delivery.

21. The multibeam system of claim 1, wherein the multibeam system is configured such that when the multibeam system is in a cleaning mode, the utility beam(s) does not directly interact with material melted by the main beam whereby the utility beam(s) is operable for ablating a surface of a base material for removing oxides, oils, and/or other debris from the surface of the base material before new material is added.

22. The multibeam system of claim 1, wherein the multibeam system is configured such that when the multibeam system is in an absorption modification mode, the utility beam(s) is operable for increasing an effective absorption rate of the main beam as with each pulse from the utility beam(s) a small portion of the material within the main beam's temperature is increased, which increases rate at which the main beam is absorbed.

23. The multibeam system of claim 1, wherein:
the multibeam system is configured for providing additional functionality to directed energy deposition (DED) processing; and
the additional functionality includes one or more of surface cleaning and/or absorption modification.

24. A directed energy deposition (DED) system comprising the multibeam system of claim 1.

25. An additive manufacturing system comprising the multibeam system of claim 1.

26. A laser powder bed fusion (LPBF) system comprising the multibeam system of claim 1.

27. A laser welding system comprising the multibeam system of claim 1.

28. A multibeam directed energy deposition (DED) beam delivery system comprising the multibeam system of claim 1.

29. A method relating to a multibeam system including a main beam and a utility beam(s), the method comprising adjustably positioning the utility beam(s) relative to the main beam, wherein:
the utility beam(s) and main beam are configured differently such that the multibeam system is asymmetric; and/or
the method comprises adjustably positioning the utility beam(s) relative to the main beam such that the utility beam(s) is positioned to work outside the main beam for a cleaning mode; and/or
the method comprises adjustably positioning the utility beam(s) relative to the main beam such that the utility beam(s) is positioned to work inside the main beam for an absorption modification mode.

30. The method of claim 29, wherein the method includes:
adjustably positioning the utility beam(s) relative to the main beam such that the utility beam(s) is positioned to work outside the main beam, and using the multibeam system for surface cleaning; and
adjustably positioning the utility beam(s) relative to the main beam such that the utility beam(s) is positioned to work inside the main beam, and using the multibeam for absorption modification.

31. The method of claim 30, wherein the utility beam(s) and main beam are configured differently such that the multibeam system is asymmetric.

32. The method of claim 29, wherein adjustably positioning the utility beam(s) relative to the main beam comprises selectively positioning the utility beam(s) to work outside or inside the main beam.

33. The method of claim 29, wherein adjustably positioning the utility beam(s) relative to the main beam comprises selectively positioning the utility beam(s) to work outside the main beam for cleaning and selectively positioning the utility beam(s) to work inside the main beam for absorption modification.

34. The method of claim 29, wherein:
the main beam comprises a continuous or constant wave laser; and
the utility beam(s) comprises a Q-switched pulse laser(s).

35. The method of claim 29, wherein the method includes configuring the main beam and the utility beam(s) in a pulse laser configuration including one or more of an orbital pulse laser configuration, an offset with interaction pulse laser configuration, an offset without interaction pulse laser configuration, and an adaptive leading pulse laser configuration.

36. The method of claim 29, wherein the method includes:
delivering the main beam and the utility beam(s) down and/or along a same optical axis; and/or
delivering the utility beam(s) from a location different than and spaced apart from a location from which the main beam is delivered; and/or
delivering the utility beam(s) co-incident but not co-linear with the main beam at a working plane.

37. The method of claim 29, wherein the method includes adjustably positioning the utility beam(s) relative to the main beam such that the utility beam(s) does not directly interact with material melted by the main beam whereby the utility beam(s) is operable for ablating a surface of a base material for removing oxides, oils, and/or other debris from the surface of the base material before new material is added.

38. The method of claim 29, wherein the method includes adjustably positioning the utility beam(s) relative to the main beam such that the utility beam(s) is operable for increasing an effective absorption rate of the main beam as with each pulse from the utility beam(s) a small portion of the material within the main beam's temperature is increased, which increases rate at which the main beam is absorbed.

39. The method of claim 29, wherein the method is performed for providing surface cleaning and/or absorption modification for a directed energy deposition (DED) system, an additive manufacturing system, a laser powder bed fusion (LPBF) system, and/or a laser welding system.

40. The method of claim 29, wherein the method is performed for providing surface cleaning of soot formation on a print of a laser powder bed fusion (LPBF) system.
